(19) United States
(12) Patent Application Publication
(10) Pub. No.: US 2026/0203441 A1
(43) Pub. Date: Jul. 16, 2026

(54) Enhancing Usage Of AI Generative Systems

(71) Applicant: ANAGOG LTD., Tel Aviv (IL)

(72) Inventors: Gil LEVY, Rehovot (IL); Igor PECHERSKY, Kareny Shomron (IL)

(21) Appl. No.: 19/135,853

(22) PCT Filed: Jan. 15, 2024
(86) PCT No.: PCT/IL2024/050059

§ 371 Date: Jun. 5, 2025

Related U.S. Application Data
(60) Provisional application No. 63/439,165, filed on Jan. 16, 2023.

(51) Int. Cl. G06F 21/62; G06F 16/2453

(52) U.S. Cl. CPC G06F 21/6245; G06F 16/24542; G06F 21/6227

(57) ABSTRACT

A method, system and product for enhancing AI generative systems. The method comprises obtaining a query and obtaining at least one detail related to a user of a client device. The query is automatically enhanced to include the at least one detail related to the user, thereby obtaining an enhanced query adapted to the user. Said enhancing is performed by the client device, thereby protecting a privacy of the user. The enhanced query is submitted to a generative Artificial Intelligence (AI) model. A response from the generative AI model is received and an output that is based on the response is provided.

### CROSS-REFERENCE TO RELATED APPLICATION

This application claims the benefit of Provisional Patent Application No. 62/969,237, titled “Edge AI in generative systems” filed Jan. 16, 2023, which is hereby incorporated by reference in its entirety without giving rise to disavowment.

### TECHNICAL FIELD

The present disclosure relates to generative AI in general, and to methods, products, and systems for making such systems more effective for a user, in particular.

### BACKGROUND

In recent years, large language models (LLMs) have propelled artificial intelligence-based generative systems to become more and more prevalent in all fields, from personal uses to commerce, industrial, scientific, and others. LLMs can generate human-like text responses to prompts, making it useful for a variety of natural language processing tasks such as language translation, text summarization, and conversation modeling.

AI-based generative systems have been shown to rival the performance of human experts on challenging tasks such as answering questions, generating coherent content, summarizing ideas, reasoning, and planning. The systems are capable of adapting to a prompt through their ability to engage in a dialog with the user, thereby generating content that is pertinent to both the query and the ongoing dialog.

LLMs can be used by entering prompts and receiving responses using all computerized devices: desktop computers, laptop computers, smartphones, tablets or others. The LLMs can be addressed using web interface or dedicated applications.

### BRIEF SUMMARY

One exemplary embodiment of the disclosed subject matter is a method comprising: obtaining a query; obtaining at least one detail related to a user of a client device; automatically enhancing the query to include the at least one detail related to the user, thereby obtaining an enhanced query adapted to the user, wherein said enhancing is performed by the client device, thereby protecting a privacy of the user; submitting the enhanced query to a generative Artificial Intelligence (AI) model; receiving a response from the generative AI model; and providing an output based on the response.

Optionally, the at least one detail is a characteristic of the user.

Optionally, the characteristic is selected from the group consisting of: age, gender, residential address, education, profession, occupation, work address, marital status, family member details, hobbies, purchases, previous address, current location, date or time of arrival to current location, mobility information of the user device, and a travel destination.

Optionally, the at least one detail related to a user is determined based on monitoring user activity of the user, the monitoring is performed locally at the user device, information gathered based on the monitoring is retained locally in at the user device.

Optionally, said obtaining the at least one detail comprises selecting the at least one detail from a set of locally retained details, wherein the selection is based on the query, thereby selecting relevant details to the query.

Optionally, said obtaining the at least one detail comprises selecting the at least one detail from a set of locally retained details, wherein said selecting excludes at least one detail, whereby protecting the privacy of the user.

Optionally, the method comprises encoding the enhanced query by the client device prior to said submitting, whereby protecting the privacy of the user.

Optionally, the at least one detail is obtained from a query submitted by the user to the generative AI model during a previous session, and wherein the at least one detail, or a prompt or response provided during the previous session are locally retained on the client device.

Optionally, the at least one detail is obtained from a query submitted by the user to another generative AI model during a previous session, and wherein the at least one detail, or a prompt or response exchanged during the previous session are locally retained on the client device.

Optionally, the enhanced query is submitted automatically and without user intervention, in response to a trigger event, wherein the query is pre-defined to be submitted in response to the trigger event.

Optionally, the trigger event is detected based on a reading from a sensor comprised in the client device or based on user activity.

Optionally, the at least one detail used for enhancing the prompt is related to the trigger event.

Optionally, the trigger event is selected from the group consisting of: arriving at a specific location or at a location of specific type, leaving a home of the user, leaving a location the user is at, a phone call the user has made or received, an e-mail or message the user has sent or received, a social media activity of the user, a person the user has met, a purchase of an item made by the user, meeting a predetermined person, a predetermined date or time.

Optionally, the query is a predefined query.

Optionally, the query is selected from a collection of preset queries.

Optionally, the query is automatically selected from the collection of preset queries based on a trigger event.

Optionally, the query is a user provided query that is manually defined by the user using the user device as a textual prompt to be provided to the generative AI model at a future time.

Optionally, the method comprises: receiving from a server an invitation to participate in a campaign, the campaign dependent upon a trigger event, the invitation comprising a template of a query; storing the invitation in a storage device associated with the client device; upon identifying an occurrence of the trigger event, and upon verifying that the campaign is relevant to the user, completing the template into the query.

Optionally, the client device comprises a sensor, and wherein the trigger event is fired in response to a reading from the sensor.

Optionally, the AI model is a Large Language Model (LLM).

Another exemplary embodiment of the disclosed subject matter is a system comprising a processor and coupled memory, the processor being adapted to perform: obtaining a query; obtaining at least one detail related to a user of a client device; automatically enhancing the query to include the at least one detail related to the user, thereby obtaining an enhanced query adapted to the user, wherein said enhancing is performed by the client device, thereby protecting a privacy of the user; submitting the enhanced query to a generative Artificial Intelligence (AI) model; receiving a response from the generative AI model; and providing an output based on the response.

Yet another exemplary embodiment of the disclosed subject matter is a computer program product comprising a non-transitory computer readable storage medium retaining program instructions, which program instructions when read by a processor, cause the processor to perform: obtaining a query; obtaining at least one detail related to a user of a client device; automatically enhancing the query to include the at least one detail related to the user, thereby obtaining an enhanced query adapted to the user, wherein said enhancing is performed by the client device, thereby protecting a privacy of the user; submitting the enhanced query to a generative Artificial Intelligence (AI) model; receiving a response from the generative AI model; and providing an output based on the response.

### THE BRIEF DESCRIPTION OF THE SEVERAL VIEWS OF THE DRAWINGS

The present disclosed subject matter will be understood and appreciated more fully from the following detailed description taken in conjunction with the drawings in which corresponding or like numerals or characters indicate corresponding or like components. Unless indicated otherwise, the drawings provide exemplary embodiments or aspects of the disclosure and do not limit the scope of the disclosure. In the drawings:

FIG. 1 illustrates an exemplary flowchart diagram of a method, in accordance with some exemplary embodiments of the disclosed subject matter;

FIG. 2 illustrates an exemplary flowchart diagram of a method, in accordance with some exemplary embodiments of the disclosed subject matter;

FIG. 3 illustrates an exemplary flowchart diagram of a method, in accordance with some exemplary embodiments of the disclosed subject matter;

FIG. 4 illustrates an exemplary flowchart diagram of a method, in accordance with some exemplary embodiments of the disclosed subject matter; and

FIG. 5 illustrates a block diagram of an apparatus, in accordance with some exemplary embodiments of the disclosed subject matter.

### DETAILED DESCRIPTION

Interaction with Generative AI models, such as Large Language Models (LLMs) (e.g., Generative Pre-trained Transformer (GPT), Pre-trained Language Model (PaLM), Bidirectional Encoder Representations from Transformers (BERT), XLNet, Text-To-Text Transfer Transformer (T5)), Vector Quantized Generative Adversarial Network (VQGAN), stable diffusion, Variational Autoencoder (VAE), Transformer-based models, or the like, is often performed by providing a prompt, also referred to as a query, and receiving responses from the generative AI. In some cases, the responses may be textual, enabling the user to seemingly converse with the generative AI model, such as by responding back, and continuing the dialog, followed by receiving further responses from the generative AI model. In other cases, the generative AI model may output a non-text output, such as a synthesized image, movie, media, or the like. The disclosed subject matter is explained in detail with respect to LLM. However, unless stated otherwise in a claim, the claimed invention is not to be narrowly construed as relating only to such type of generative AI model and other models may also be used.

One technical problem dealt with by the disclosed subject matter is the need to improve responses from a generative AI model, and make them better tailored for the user. In currently available systems, the generative AI models are unaware of the user characteristics unless specifically provided by the user, and may thus provide substantially the same responses to any user that will submit the same prompts, regardless of the personal characteristics of the user. This is unlike a human responder, who is likely to know or at least ask about some characteristics of the user, and then provide a more personalized response. Thus, although some generative AI models maintain a dialog with the user, where the user provides the prompts and reacts to suggestions made by the generative AI model, the information carried in the prompt is limited to what the user explicitly entered, which may provide for sub optimal responses.

Another technical problem dealt with by the disclosed subject matter relates to security, where the user's privacy may be compromised due to personal details being specified in the prompt, for example in order to obtain more accurate and personalized responses. If personal, characteristics, or identifying details are transmitted with the prompt as text, they may be intercepted by third parties, whether malicious or not, thereby the user's privacy may be compromised. There is thus a need to protect the user' privacy.

Yet another technical problem dealt with by the disclosed subject matter is the need to assist the user in situations where the user may be too busy, may not think about getting assistance, or may not even be aware of available data or other helpful materials. Thus, in such situations, the user may find such help useful even if the user did not explicitly ask for it. A similar situation may occur when the user is not even aware of promotions or other benefits the user is entitled to and may enjoy using.

Yet another technical problem dealt with by the disclosed subject matter is the need to improve the response time of a generative AI model, which constitutes of the processing time by the generative AI model, plus the back and forth transmission time of the query and the responses.

One technical solution of the disclosure relates to a system and method for improving the responses received from a generative AI model, by enhancing or enriching the query submitted to the generative AI model. The query may be enhanced or enriched by updating the query and making it more specific and tailored to the user.

The usage of computing platforms by a user, includes the exposure of enormous amounts of data about the user. Such data may include but is not limited to the user's age, gender, residential address, previous addresses, education, profession, occupation, work address, marital status, family member details, contact persons, hobbies, items the user has purchased or is regularly buying, current location, date or time of arrival to current location, where the user has arrived from to the current location, mobility information of the user device (also referred to as client device), destination, or others. Thus, such details may be used for generating a user's profile. It is appreciated that some collected details may still be useful although they are not part of the user's profile.

By using one or more of these details or the profile to enhance a prompt transmitted to a generative AI model, the responses provided by the generative AI model may be more personalized and adapted to the user's needs. For example, if the user is a student at NYU, and the prompt is “Where can I find study materials for history?” the prompt may be enhanced into “As a student in NYU, where can I find study materials for my history class?” Without the “student” information, the results may include a variety of sources such as textbooks, online articles, and historical sites. With the student information, the results may be more focused on specific textbooks and class materials provided by the user's school or professor.

Additionally or alternatively, the information may include details related to the current context of the user, for example where the user is, what the user is currently doing, the time and date, or the like. For example, if it is evening time, and the user has just arrived at a location, and a prompt the user may issue is “What restaurant is recommended?”, the prompt may be enhanced into “What restaurant is recommended for dinner in <city>?”, thereby obtaining better results, and saving one or more rounds of further prompts and responses.

Another technical solution of the disclosure relates to monitoring the user's activities with the device, and retaining information related to the user, such that the information can be used for enriching queries transmitted to a generative AI model.

In some embodiments, monitoring and retaining of the user's activities and profile may be performed locally, without sending or receiving information to or from other devices. For example, locations and routes of the user may be obtained by the device as the user uses a navigation application, possibly combined with a calendar application, purchased items, or items the user expressed interest in may be determined as the user uses shopping applications, a lot of information about the user's daily life can be learned from messages exchanged in messaging applications, or the like.

In some embodiments, information may also be collected by monitoring previous sessions of the user with the generative AI model, and/or with one or more other generative AI models. Currently, each session is standalone and the information embedded therein is unavailable to the user or the device once the session is over. In accordance with the disclosure, the prompts, responses, and reactions to the responses may also be retained locally and used as an information source for enriching future sessions.

It is appreciated that a profile of the user may be generated, based not only on raw data but also on processing the same. For example, sleep and wake patterns of the user may be deduced, nutritional principles such as being a vegetarian or a vegan may be deduced from shopping history, fields of interest may be deduced from Internet pages the user is visiting frequently, or the like. In some cases, such deductions may be determined using prediction models that are based on the raw data and/or processed data.

The information and/or profile may be stored in a local dedicated location, using a defined structure, which may be indexed. Thus, the information may be obtained and retained locally, and not transmitted to any third party excluding as described below.

Once the information is available, it can be used for enriching prompts as detailed above, by enhancing the prompt with one or more details or aspects of the user's profile stored locally on the device.

Continuing the example above, the prompt may be adapted to enquire “What restaurant is recommended for dinner in Paris for a vegetarian?”

In another example, if the monitoring and processing indicates that the user is an “early riser”, a prompt of “What are good workout plans for weight loss” may obtain workout plans suitable for any time of the day but not necessarily for early morning. Enhancing the prompt to enquire “What are good workout plans for weight loss for an early riser”, which may obtain different exercise plans that maximize the benefits of exercising early.

In some exemplary embodiments, the method includes the utilization of a learnable modality tokenizer, which employs convolutional layers to process user profiles and associated details as a unique non-verbal modality. This processed information is then provided to the generative AI (e.g., LLM) in tandem with the initial prompt. The system may incorporate a pre-trained and frozen vision-language model, such as the Contrastive Language-Image Pre-training (CLIP) model, to enhance the model's ability to interpret and respond to such multi-modality prompts with improved contextual relevance and accuracy.

In some embodiments, all profiles and details about the user may be used when enhancing the prompts, such that it is left to the discretion of the generative AI model which of the details are relevant and which are not. In other embodiments, one or more specific details that may be relevant may be selected locally, such that only these details are used, and irrelevant details are excluded.

However, in further embodiments, some irrelevant or misleading details may intentionally be used for enhancing the prompt, in order to protect the user's privacy. For example, the user's age may be changed, irrelevant items the user has allegedly purchased may be added, or the like. In some embodiments, irrelevant details may be added, for example the type of beer preferred by the user when the prompt relates to children's toys, or the like. Such details, also referred to as “noise”, may mislead a malicious party if the prompt is intercepted, and also prevent the owner of the generative AI model from ascertaining personal details about the user.

Yet another technical solution of the disclosure relates to encoding the prompt as enriched, prior to transmitting the prompt to the generative AI model. The encoding may prevent a third party that succeeded in intercepting the prompt from utilizing it to obtain personal details of the user.

Yet another technical solution of the disclosure relates to predetermined trigger events, which when detected, a predetermined prompt is automatically transmitted and responses are received.

The prompts associated with a trigger event may be selected from a collection of preset prompts. For example, a trigger event may be that the user has landed from a flight, and the prompt may be searching for a restaurant in the city where the user has landed. Thus, anytime the user lands at a location, the trigger event is detected, and a corresponding prompt is automatically transmitted. It is appreciated that any number and type of trigger events and corresponding prompts for each trigger may be issued. For example, when the user goes shopping, a prompt for finding out about sales or promotions of the specific shop the user is at may be issued.

Trigger events may be detected upon information received from one or more sensors embedded within or associated with the client device, such as a location sensor, a sensor for measuring a physical parameter of the user, or the like. Further factors for detecting a trigger event may be reports received from one or more applications. For example, if it is detected that the user is tired and is driving in a jammed road, a prompt enquiring about nearby coffee shops may be transmitted, and a message may be provided to the user, suggesting that the user stops for coffee.

As above, the prompt may be enriched with the preferences of the user. For example a prompt asking about promotions may include items that the user has previously purchased, if the user is shopping for shoes, the prompt may be enhanced with the user's foot size, or the like.

In some embodiments, the prompt may be enriched with information related to the trigger event, for example where the user is shopping. Thus, occurrence of the trigger event may affect the actual transmission of the prompt, and details of the trigger event may be used for enriching the prompt. Moreover, in some situations, a plurality of prompts may be associated with one trigger event, and the selection which one (or more) to transmit may depend on the trigger event, and as above also on the context, and on additional user details.

The prompts may be default prompts, prompts provided by a third party, prompts provided by a user for ad-hoc uses, prompts provided by the user to be used as presets or templates, whether [symbol] elated to trigger events or not, or the like.

In some embodiments, the trigger event and the associated prompt may not be associated solely with the user, but may be pre-provided by a third party. The third party may transmit a message to the client device, optionally not displayed to the user. The client device may verify whether the message is of interest to the user, exercising for example on-device matching with the user's profile or other details. In one example, if the message relates to car insurance, the client device may verify whether the user owns a car, and disregard the message if not.

The message may comprise a trigger event to be detected, such as arriving home, entering a chain store, or the like. Upon the detection of the trigger event, the prompt, for example a prompt related to enquiring about the car insurance, may then be transmitted. The prompt may be enriched with relevant details, such as the details of the car owned by the user, the number of miles the user has driven in the past years, or the like, wherein the information may have been gathered by the client device through monitoring the user's activity.

Yet another technical solution of the disclosure relates to architectures of a system for improving the performance of generative AI models.

In some embodiments, if the generative AI model is provided by a third party, the format of the prompts needs to be adapted to a format acceptable by the generative AI model, such as plain text.

In further embodiments, the generative AI model may be proprietary, and can thus be adapted to receive a prompt in any required format, including for example encoded feature vectors.

In yet further embodiments, an Software Development Kit (SDK) may be provided for monitoring the user activity, retaining information, and performing additional operations. The SDK may be useful for assisting developers of generative AI model to develop a generative AI model that utilizes prompt enhancement. A generative AI model may activate functionalities of the SDK for providing additional options. For example, the generative AI model may receive an encoded feature vector, and activate the SDK for decoding the feature vector into plain text, thereby enabling secure transmission of the prompt and user details enhancing the prompt.

In some embodiments, a more compact version of a generative AI model may be provided on the client device, while the full scale generative AI model is remote, for example is operated by a server addressed by the client device through a computer communication network, such as the Internet. The more compact version may be generated upon a smaller training set, support fewer subjects, or be limited in any other manner. If responses by the local generative AI model are satisfactory, the load on the server has been reduced, transmission volume was decreased, and the response time may have been reduced. Upon unsatisfactory responses from the compact generative AI model, the prompt may be transmitted to the full scale generative AI model for obtaining better responses with which the user may be satisfied.

One technical effect of the disclosure is the option to receive from a generative AI model responses which are more adapted to the user and/or the context. By enriching prompts with details of the user, such as personal, professional, or other details, the responses may be more personalized and better adapted to the user. Additionally or alternatively, enhancing the prompts with context details, such as time or place, better adapts the responses to the specific circumstances of the user. By selecting details relevant to the query and deselecting irrelevant details, the prompt may be made more accurate, which may result in better adapted responses.

Another technical effect of the disclosure relates to better user privacy protection. For example, by adding one or more irrelevant or incorrect (“noise”) information items, the user's privacy may be better maintained as these details may mislead a party that intercepts the prompt.

In another example, locally monitoring the user's activities and retaining the user's details provides for lower risk of compromising the user's data, as the data is only transmitted when used. Moreover, by encoding the data, the risk may be reduced further.

Yet another technical effect of the disclosure relates to providing information to the user without requiring the user to perform any explicit action. By automatically initiating a query in response to detecting a trigger event, the user may be presented with relevant information at the right time with zero effort.

Yet another technical effect of the disclosure relates to the provisioning of information or promotion provided by a third party, wherein the information or promotion may be verified to be relevant to the user, and received in response to detecting a trigger event, without any action by the user.

Yet another technical effect of the disclosure relates to enhancing the generative AI model to perform additional operations, by activating a corresponding SDK. For example, the generative AI model may be adapted to receive an encoded prompt or prompt of any format, and activate the SDK for decoding the prompt, thereby supporting additional input formats, enhancing the security of the user's data, or the like.

Yet another technical effect of the disclosure relates to distributing the computational load between the user's device and a server, which is also useful in reducing transmission volume and improving data security, as fewer prompts are transmitted over a network to a remote generative AI model.

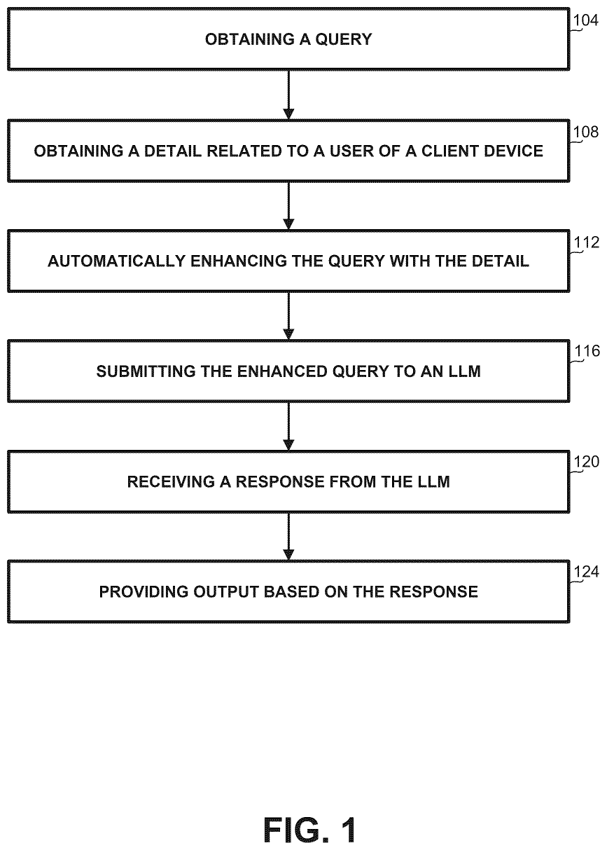

The methods of FIG. 1-FIG. 4 below may be executed by an application executed by a computing device. The computing device may be a desktop computer, a laptop computer, a mobile phone, or the like. The application may be implemented as a web page, as an application, or the like, and may communicate with a local or remote LLM.

Referring now to FIG. 1, showing an exemplary flowchart diagram of a method, in accordance with some exemplary embodiments of the disclosed subject matter.

At step 104, a query may be obtained. The query may be obtained from a user using a client device for manually defining the query, by entering a prompt to be provided to the LLM at a future time. The user may type the prompt or enter the prompt as an audio signal which is transformed into text using a speech to text engine.

In some embodiments, the query may be selected from one or more predefined user-provided queries. In further embodiments, the query may be selected automatically from a set comprising one or more preset queries, wherein the query may be automatically selected upon a trigger event or in accordance with a current context, user details, or the like. In some embodiments, one or more preset queries to select from may be provided by a third party in association with a trigger event.

At step 108, at least one detail related to a user of the client device may be obtained. The detail may be obtained from a locally retained collection of details, related for example to the user's personal details, professional details, or others. In some embodiments, a detail related to a current context of the user may also be selected.

At step 112, the detail may be used for enhancing the query, for example adding the detail to the query, adding the detail to the query with some additional wording, such as “as an <occupation name> I would like to buy . . . ”, or “living in <city> I am interested in finding a gym class”, or the like.

At step 116, the enhanced query may be submitted to an LLM, either as plain text, or in another format acceptable by the relevant LLM, such as a feature vector. Most currently available LLMs are adapted to receive queries in plain text format. An LLM may be adapted to receive a query in a different or proprietary format, or call an SDK adapted to transform the query from the proprietary format to a format acceptable by the LLM. In some embodiments, the query may be encoded prior to being transmitted.

At step 120, one or more responses may be received from the LLM, for example in the form of free text, a list, or the like.

At step 124, output may be provided to the user, based on the received responses. The output may be provided as text, a list, or the like. In further embodiments, the output may be processed and displayed as an HTML page, as audio after being processed by a text to speech engine, or the like. In yet further embodiments, the output may be summarized, translated, or otherwise processed prior to providing to the user.

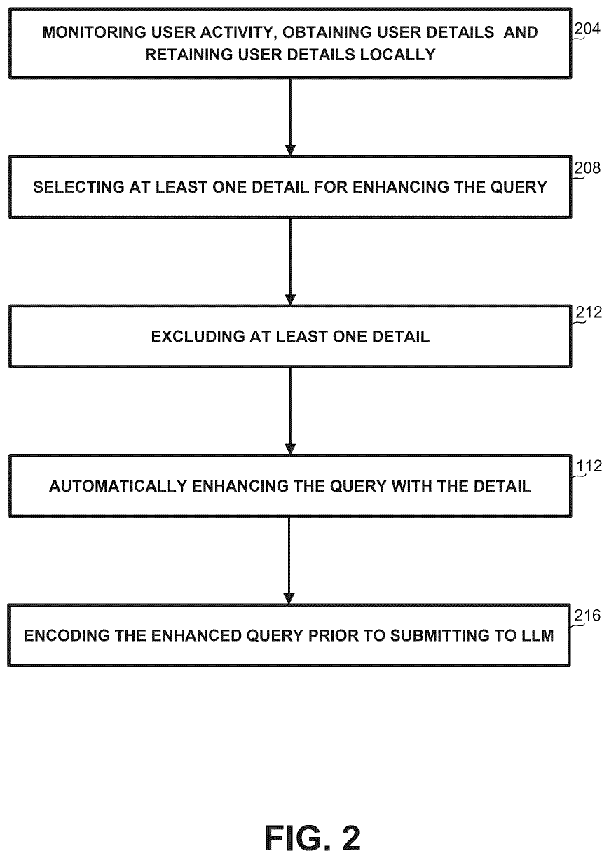

Referring now to FIG. 2, showing an exemplary flowchart diagram of a method, in accordance with some exemplary embodiments of the disclosed subject matter.

FIG. 2 shows a method detailing step 108 and step 112 of FIG. 1.

At step 204, the user's activities may be monitored over time, and user details may be retained. In some embodiments, the user details may be retained and managed locally, for example on a storage device of the user's device.

Monitoring may include collecting and analyzing the user's activities in a plurality of applications, such as messaging applications, e-mail applications, navigation applications, shopping applications, registration to different sites or services, or the like.

Monitoring may also include collecting data from previous sessions with the addressed LLM, and/or with other LLMs. Thus, data previously entered during any of the sessions is not lost when the session is over, but rather retained and used for retrieving details in future sessions.

The collected data may be processed, and indexed or otherwise retained, and a profile of the user may be generated such that data relevant to a certain need may be retrieved. For example, the user's age, gender, and address may be obtained when the user fills out an online form, the user's education may be retrieved from filling application forms to jobs or educational institutes, or the like.

At step 208, one or more details may be selected from the retained details, as being relevant to the query. Relevancy may be determined by a trained Artificial Intelligence (AI) engine, a rule engine, or the like. For example, food preferences may be relevant when searching a restaurant or asking about a city, but not when asking about a historical event.

Further details may be selected from the current context of the user, for example where the user is, both in terms of geographical location and a type of location, such as home, office, stadium, shopping mall, etc., where the user arrived from, the time and date, weather, or the like.

At step 212, one or more irrelevant details may be excluded from the query, so as to keep the query more focused on the user's characteristics.

In some embodiments, instead of selecting some details to enhance the query (step 208) and deselecting others (step 212), the full content of the user details or profile, and/or the context may be used for enhancing the query, and the LLM may determine which data items are to be used in generating the response.

At step 112, as detailed above, the selected details or the whole user profile and/or context, may be used for enhancing the query, for example added as a bulk, integrated into the query text, or the like.

In some embodiments, once the query is enhanced, at step 216 the query may be encoded prior to being transmitted, in order to eliminate transmission of the user's details over the network as plain text.

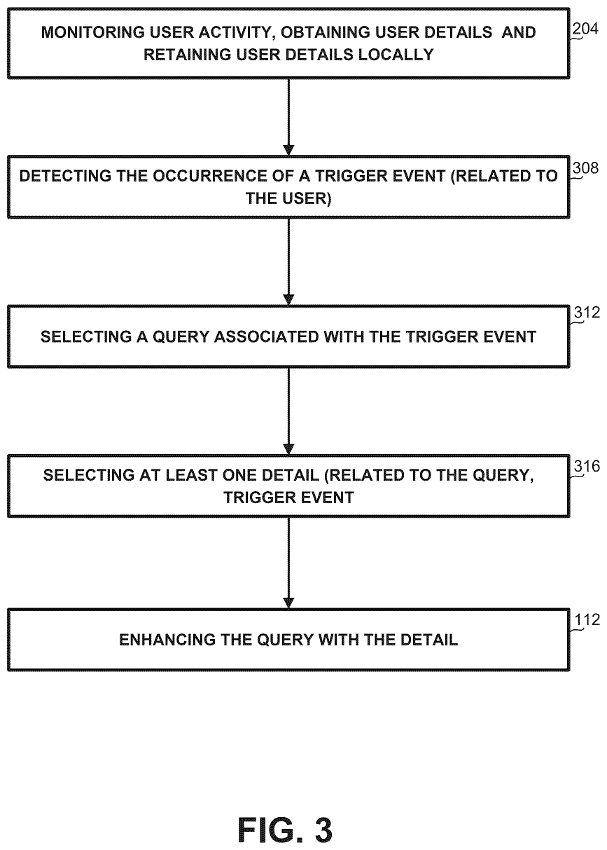

Referring now to FIG. 3, showing an exemplary flowchart diagram of a method, in accordance with some exemplary embodiments of the disclosed subject matter.

At step 204, similarly to step 204 of FIG. 2, the user's activity may be monitored, and the user's details may be retained locally.

At step 308, the occurrence of a trigger event may be detected. The trigger event may be a combination of one or more conditions related to the user or the context, such that when all conditions hold, a certain action is to be taken, such as generating and transmitting a query.

The trigger event may be detected upon a reading from a sensor embedded within the client device and sensing an environmental parameter, such as a location sensor, an Inertial Measurement Unit (IMU) or the like, a biological parameter of the user such as heart rate or blood pressure, a date or time, or the like. The trigger event may also be detected upon user profile, user activity, or context, for example by ongoing checking for one or more trigger events defined for the user. Some exemplary trigger events may be: arriving at a specific location or at a location of specific type, leaving a home of the user, leaving a location the user is at, a phone call the user has made or received, an e-mail or message the user has sent or received, a social media activity of the user, a person the user has met, a purchase of an item made by the user, meeting a predetermined person, and a predetermined date or time.

Once the trigger event is detected, at step 312 a query related to the trigger event may be selected. In some cases there may be a single query associated with the trigger event, in which case selection is trivial. In other cases, there may be a plurality of queries associated with one or more trigger events, and a relevant query may be selected based on the specific conditions. For example, if the trigger even is that the user arrived at a location in a flight, the relevant query may be selected upon the time of day. In the morning, the query may relate to places for sightseeing, and in the evening the query may relate to a restaurant for dinner.

At step 316, a detail related to the trigger event may be selected from the user profile or details, from the context, or from the trigger event itself. For example, the detail may be the name of the city the user came from, artistic preferences, or the like.

Thus, the trigger event may be used for any one or more of: determining whether a query is to be submitted, selecting the specific query, and enhancing the query.

At step 112, similarly to step 112 of FIG. 1, the detail may be used for enhancing the query. The flow may then continue as in FIG. 1, with submitting the query (step 116), receiving responses (step 120) and providing output to the user based on the response (step 124).

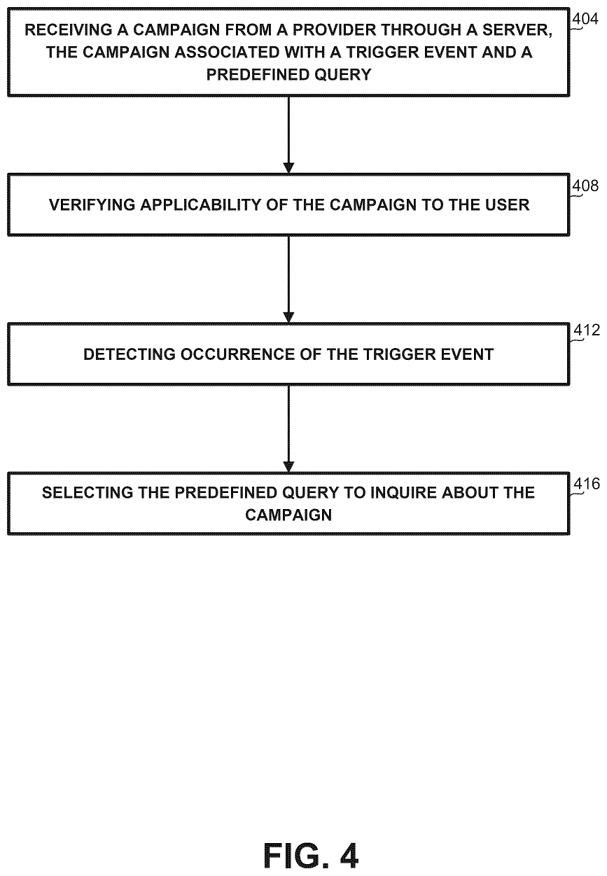

Referring now to FIG. 4, showing an exemplary flowchart diagram of a method, in accordance with some exemplary embodiments of the disclosed subject matter.

At step 404, a campaign may be received at a client device from a third party. The campaign may be targeted, knowing that it is relevant to a user of the device, or widespread without particular targeting. The campaign may relate to a certain product or service to be suggested to the user.

The campaign may be associated with a trigger event, such that no immediate action is taken in response to receiving the message, but only when the conditions of the trigger event hold. The campaign may also be associated with one or more predefined queries to be transmitted upon the detection of the trigger event.

At step 408, the applicability of the campaign to the user may be verified. For example, if the campaign relates to car insurance, it may be validated whether the user owns a car and its insurance renewal is expires within a predetermined time frame.

At step 412, the trigger event may be detected. It is appreciated that in the absence of trigger event, this step may be omitted, and the method may continue immediately or any time after the campaign is found to be applicable to the user.

At step 416, upon the detection of the trigger event, if one is associated with the campaign or at any time otherwise, one or more of the queries comprised in the campaign may be selected. The query may be selected upon the user profile or details, the context or the like, for example using a trained AI engine.

The method may then continue as in FIG. 1, with selecting a detail of the user or context (step 108), automatically enhancing the query (step 112), submitting the query (step 116), receiving a response (step 120) and providing output to the user based on the response (step 124).

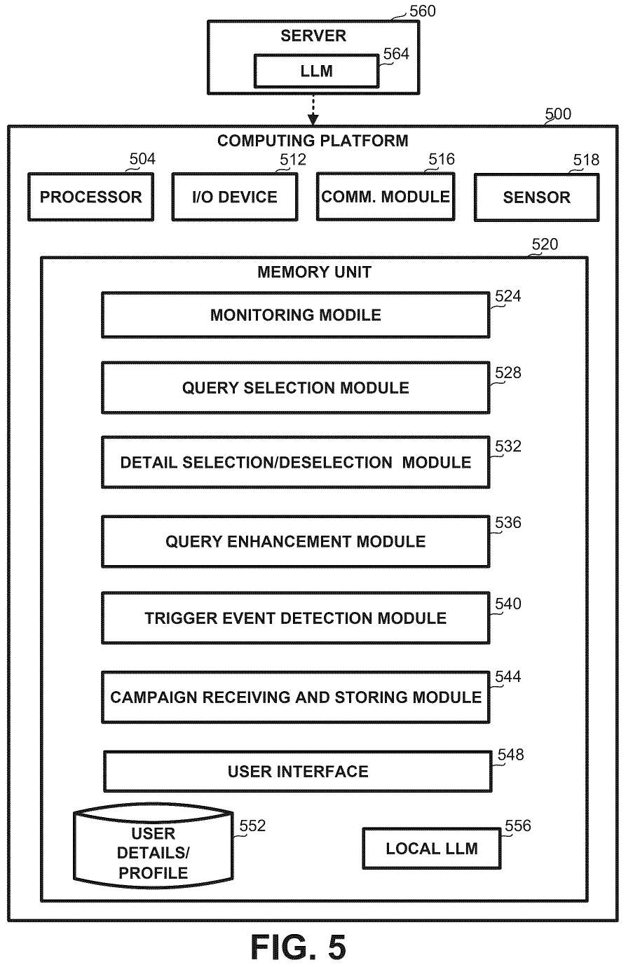

Referring now to FIG. 5, showing a block diagram of an apparatus in accordance with some exemplary embodiments of the disclosed subject matter.

In some exemplary embodiments, the apparatus may be comprised in a client device, such as Computing Platform 500 which may be a desktop computer, a laptop computer, a tablet, a smartphone, a personal assistant, or the like. In some exemplary embodiments, Apparatus 500 may comprise one or more Processor(s) 504, an Input/Output (I/O) Module 508, a Storage Device 512, or the like.

In some exemplary embodiments, Computing Platform 500 may comprise a Processor 504, which may be a Central Processing Unit (CPU), a Graphical Processing Unit (GPU), a microprocessor, an electronic circuit, an Integrated Circuit (IC) or the like. Processor 504 may be utilized to perform computations required by Computing Platform 500 or any of its subcomponents, or to perform steps of the methods shown in any of FIG. 1-FIG. 4.

In some exemplary embodiments, Computing Platform 500 may comprise an Input/Output (I/O) Module 508. I/O Module 508 may comprise a keyboard, a touch screen, a mouse, a speaker, a microphone, or the like and may be utilized for receiving input and providing output to a user of Computing Platform 500.

In some exemplary embodiments, Computing Platform 500 may comprise Communicating Device 512 for communicating with other computing platforms, such as one or more Servers 560, via any communication channel, such as a Wide Area Network, a Local Area Network, intranet, Internet or the like, and using any applicable communication protocol.

In some exemplary embodiments, Computing Platform 500 may comprise at least one Sensor 518. Sensor 518 may be a location sensor, an IMU, a temperature sensor, a bodily parameter sensor, a barometric pressure sensor, or any other sensor, adapted to sense an environmental parameter.

Server 560 may also be a computing platform. Server 560 may retain an LLM 564 adapted to receive prompts from one or more clients such as Computing Platform 500 and to provide responses.

In some exemplary embodiments, Computing Platform 500 may comprise Memory Unit 520. Memory Unit 520 may be a hard disk drive, a Flash disk, a Random Access Memory (RAM), a memory chip, or the like. In some exemplary embodiments, Memory Unit 520 may retain program code operative to cause Processor 504 to perform acts associated with any of the subcomponents of Computing Platform 500.

It is appreciated that the detailed components are in addition to components of the device intended for other purposes, such as all purposes provided by a desktop computer, a laptop computer, a smartphone, or the like.

Memory Unit 520 may be utilized to retain a Monitoring Module 524. Monitoring Module 524 may be adapted to monitor the user activity and retain details about the user. The activity may be monitored by the usage of one or more applications, such as navigation, phone, any messaging system, shopping applications, trip planning applications, or the like. The retrieved details may be stored locally on User Details/Profile Storage 552 which may be stored within Memory Unit 520.

Memory Unit 520 may be utilized to retain a Query Selection Module 528, for selecting one or more queries to be enhanced and transmitted, according to the context or trigger event, such as on step 312 of FIG. 3.

Memory Unit 520 may be utilized to retain a Detail Selection/Deselection Module 532, for selecting which details are to be used for enhancing a query (either because the details are required, or as “noise”), and which details should be excluded from a query.

Memory Unit 520 may be utilized to retain a Query Enhancement Module 536 for enhancing a query with one or more selected details. Enhancement can take the form of adding all user details as a bulk, incorporating the details to generate a human readable sentence, or the like.

It is appreciated that Memory Unit 520 may comprise standard components or modules for transmitting the query, receiving responses, or other standard activities associated with a Memory Unit 520 may be utilized to retain a Trigger Event Detection Module 540 for monitoring the conditions associated with one or more trigger events, and identifying when all conditions hold for a certain event.

Memory Unit 520 may be utilized to retain a Campaign Receiving and Storing Module 544, for receiving one or more campaigns as detailed on step 404 of FIG. 4, and storing them, such that they can be monitored and the queries may be submitted.

Memory Unit 520 may be utilized to retain a User Interface 548 for receiving information from user, such as one or more queries to be submitted, or stored as presets. User Interface 548 may be also useful in providing information to the user, such as responses to queries, whether consciously submitted by the user, or transmitted automatically in response to detecting a trigger event.

In some embodiments Computing Platform 500 may comprise Local LLM 556, which may be a small scale version of LLM 564. In some embodiments, a prompt may be addressed to Local LLM 556, and only if the responses are unsatisfactory, the prompt may be further addressed to LLM 564. Local LLM 556 may be obtained by training on fewer cases than LLM 564, to include less subjects, or the like. This architecture may provide for better preserving the user's privacy, as in many occasions no personal information is transmitted by the client device. Moreover, the usage of local LLM 556 may provide for faster response time, as the transmission time of the query and response is saved.

The disclosed subject matter may be a system, a method, and/or a computer program product. The computer program product may include a computer readable storage medium (or media) having computer readable program instructions thereon for causing a processor to carry out aspects of the disclosed subject matter.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the disclosed subject matter may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the disclosed subject matter.

Aspects of the disclosed subject matter are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the disclosed subject matter. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the disclosed subject matter has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A method comprising:
obtaining a query;
obtaining at least one detail related to a user of a client device;
automatically enhancing the query to include the at least one detail related to the user, thereby obtaining an enhanced query adapted to the user, wherein said enhancing is performed by the client device, thereby protecting a privacy of the user;
submitting the enhanced query to a generative Artificial Intelligence (AI) model;
receiving a response from the generative AI model; and
providing an output based on the response.

2. The method of claim 1, wherein the at least one detail is a characteristic of the user.

3. The method of claim 2, wherein the characteristic is selected from the group consisting of:
age,
gender,
residential address,
education,
profession,
occupation,
work address,
marital status,
family member details,
hobbies,
purchases,
previous address,
current location,
date or time of arrival to current location,
mobility information of the user device, and
a travel destination.

4. The method of claim 1, wherein the at least one detail related to a user is determined based on monitoring user activity of the user, the monitoring is performed locally at the user device, information gathered based on the monitoring is retained locally in at the user device.

5. The method of claim 1, wherein said obtaining the at least one detail comprises selecting the at least one detail from a set of locally retained details, wherein the selection is based on the query, thereby selecting relevant details to the query.

6. The method of claim 1, wherein said obtaining the at least one detail comprises selecting the at least one detail from a set of locally retained details, wherein said selecting excludes at least one detail, whereby protecting the privacy of the user.

7. The method of claim 1, further comprises encoding the enhanced query by the client device prior to said submitting, whereby protecting the privacy of the user.

8. The method of claim 1, wherein the at least one detail is obtained from a query submitted by the user to the generative AI model during a previous session, and wherein the at least one detail, or a prompt or response provided during the previous session are locally retained on the client device.

9. The method of claim 1, wherein the at least one detail is obtained from a query submitted by the user to another generative AI model during a previous session, and wherein the at least one detail, or a prompt or response exchanged during the previous session are locally retained on the client device.

10. The method of claim 1, wherein the enhanced query is submitted automatically and without user intervention, in response to a trigger event, wherein the query is pre-defined to be submitted in response to the trigger event.

11. The method of claim 10, wherein the trigger event is detected based on a reading from a sensor comprised in the client device or based on user activity.

12. The method of claim 10, wherein the at least one detail used for enhancing the prompt is related to the trigger event.

13. The method of claim 10, wherein the trigger event is selected from the group consisting of: arriving at a specific location or at a location of specific type, leaving a home of the user, leaving a location the user is at, a phone call the user has made or received, an e-mail or message the user has sent or received, a social media activity of the user, a person the user has met, a purchase of an item made by the user, meeting a predetermined person, a predetermined date or time.

14. The method of claim 1, wherein the query is a predefined query.

15. The method of claim 1, wherein the query is selected from a collection of preset queries.

16. The method of claim 15, wherein the query is automatically selected from the collection of preset queries based on a trigger event.

17. The method of claim 1, wherein the query is a user provided query that is manually defined by the user using the user device as a textual prompt to be provided to the generative AI model at a future time.

18. The method of claim 1, further comprising:
receiving from a server an invitation to participate in a campaign, the campaign dependent upon a trigger event, the invitation comprising a template of a query;
storing the invitation in a storage device associated with the client device;
upon identifying an occurrence of the trigger event, and upon verifying that the campaign is relevant to the user, completing the template into the query.

19. The method of claim 18,
wherein the client device comprises a sensor, and
wherein the trigger event is fired in response to a reading from the sensor.

20. The method of claim 1, wherein the AI model is a Large Language Model (LLM).

21. A system comprising a processor and coupled memory, the processor being adapted to perform:
obtaining a query;
obtaining at least one detail related to a user of a client device;
automatically enhancing the query to include the at least one detail related to the user, thereby obtaining an enhanced query adapted to the user, wherein said enhancing is performed by the client device, thereby protecting a privacy of the user;
submitting the enhanced query to a generative Artificial Intelligence (AI) model;
receiving a response from the generative AI model; and
providing an output based on the response.

22. A computer program product comprising a non-transitory computer readable storage medium retaining program instructions, which program instructions when read by a processor, cause the processor to perform:
obtaining a query;
obtaining at least one detail related to a user of a client device;
automatically enhancing the query to include the at least one detail related to the user, thereby obtaining an enhanced query adapted to the user, wherein said enhancing is performed by the client device, thereby protecting a privacy of the user;
submitting the enhanced query to a generative Artificial Intelligence (AI) model;
receiving a response from the generative AI model; and
providing an output based on the response.
